(19) United States
(12) Patent Application Publication
(10) Pub. No.: US 2024/0061690 A1
(43) Pub. Date: Feb. 22, 2024

(54) ISSUING AN INTENT-BASED BLOCKING ACTION

(71) Applicant: International Business Machines Corporation, Armonk, NY (US)

(72) Inventors: Melanie Dauber, Oceanside, NY (US); Zachary A. Silverstein, Georgetown, TX (US); Jacob Ryan Jepperson, St. Paul, MN (US); Spencer Thomas Reynolds, Austin, TX (US); Jeremy R. Fox, Georgetown, TX (US); Alexander James Parker, Cornelius, NC (US)

(21) Appl. No.: 17/890,146

(22) Filed: Aug. 17, 2022

(51) Int. Cl. G06F 9/451; G06F 16/954

(52) U.S. Cl. CPC G06F 9/451; G06F 16/954

(57) ABSTRACT

A computer-implemented method according to one embodiment includes embedding natural language processing (NLP) and/or user action capture into a browser to monitor a user's intent when navigating web page(s) within the browser. An indication of a navigation to a first web page via the browser is received and it is determined whether a first action attempted to be taken on the first web page matches the user's intent. In response to a determination that the first action attempted to be taken on the first web page does not match the user's intent, an intent-based blocking action is issued to prevent the first action on the first web page. A computer program product according to another embodiment includes a computer readable storage medium having program instructions embodied therewith. The program instructions are readable and/or executable by a computer to cause the computer to perform the foregoing method.

### BACKGROUND

The present invention relates to graphical user interfaces (GUIs), and more specifically, this invention relates to issuing intent-based blocking actions to prevent actions that do not match a user's intent.

In a digital age, tasks are often performed via GUIs. Some of these GUIs are configured to include a first output illustration configuration which may include one or more graphical icons in order to enable a user action, e.g., selection, to be made on a touchscreen portion of a display device that includes the GUI. In response to such an action being made, a second illustration configuration that corresponds to the action may be output for displaying on the GUI.

### SUMMARY

A computer-implemented method according to one embodiment includes embedding natural language processing (NLP) and/or user action capture into a browser to monitor a user's intent when navigating web page(s) within the browser. An indication of a navigation to a first web page via the browser is received and it is determined whether a first action attempted to be taken on the first web page matches the user's intent. In response to a determination that the first action attempted to be taken on the first web page does not match the user's intent, an intent-based blocking action is issued to prevent the first action on the first web page.

A computer program product according to another embodiment includes a computer readable storage medium having program instructions embodied therewith. The program instructions are readable and/or executable by a computer to cause the computer to perform the foregoing method.

A system according to another embodiment includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A.

FIGS. 3A-3C depict the progression of a GUI architecture, in accordance with several embodiments.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods, and computer program products for issuing intent-based blocking actions to prevent actions that do not match a user's intent.

In one general embodiment, a computer-implemented method includes embedding natural language processing (NLP) and/or user action capture into a browser to monitor a user's intent when navigating web page(s) within the browser. An indication of a navigation to a first web page via the browser is received and it is determined whether a first action attempted to be taken on the first web page matches the user's intent. In response to a determination that the first action attempted to be taken on the first web page does not match the user's intent, an intent-based blocking action is issued to prevent the first action on the first web page.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as intent-based blocking management in block 200 for issuing intent-based blocking actions to prevent actions that do not match a user's intent. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

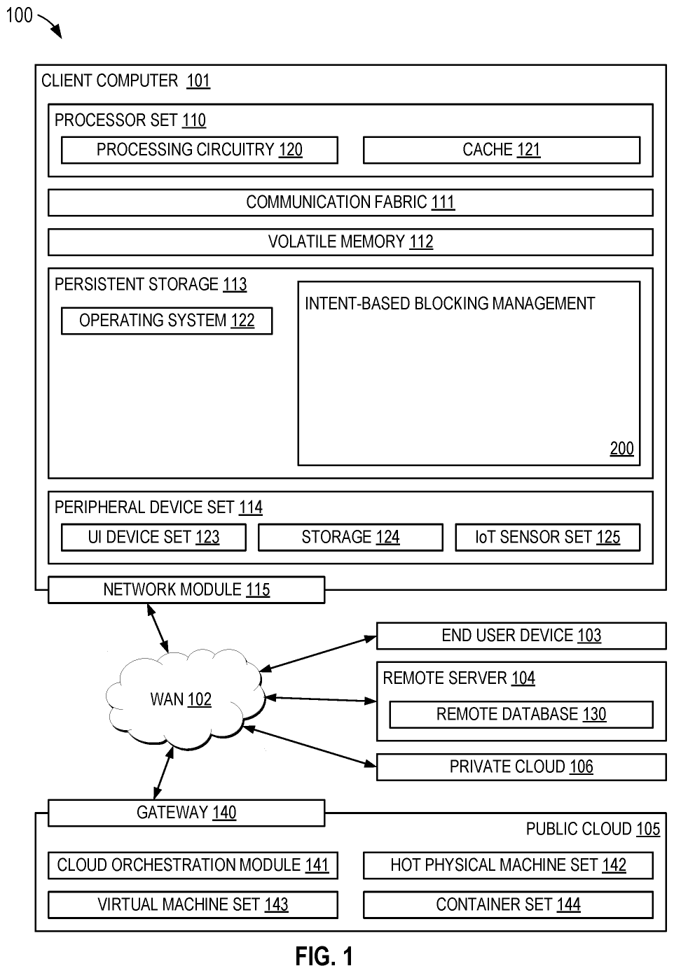

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As mentioned elsewhere above, in a digital age, tasks are often performed via GUIs. Some of these GUIs are configured to include a first output illustration configuration which may include one or more graphical icons in order to enable a user action, e.g., selection, to be made on a touchscreen portion of a display device that includes the GUI. In response to such an action being made, a second illustration configuration that corresponds to the action may be output for displaying on the GUI.

Skilled designers and choice architects often create and design these GUIs to increase a likelihood that users will take specific actions. This is useful when such user actions are the actions that the user intends to take and are in the user's best interest. However, business interests often drive the design. This sometimes results in “dark user interface (UI) patterns,” which are intentionally designed tricks to encourage users to take an action the user likely did not want to take and/or makes it relatively very difficult to take an action that the user intends to take. Dark patterns emphasize short-term gains and diminish the credibility and trust of the vendor. Accordingly, there is a need to assist users in avoiding dark patterns and realize when users are being deceived by an interface. This way, actions may be performed to counter an action taken to what the user intends.

In sharp contrast to the deficiencies described above, various embodiments and approaches described herein process contextual information while a user navigates a GUI, e.g., such as on a web page. Subsequent to a determination that a user indicates an intent to take an action, and then quickly thereafter selects a confirmation that is counter to the initial intent, a disparity may be detected, and ameliorative actions may be provided. Furthermore, in response to detecting a clear and present intent that would deceive a common user within a process flow, the techniques of various embodiments and/or approaches described herein provide an alert to the user to be aware of possible ethical workflow concern(s) whether overt or not.

More specifically, a first core novelty of various embodiments and approaches described herein includes techniques to capture dark pattern content, applications, and sites based on a disparity of actions. Another core novelty of various embodiments and approaches described herein includes techniques that enable an extension of the techniques of the first core novelty described above to enable a second core novelty. In this second core novelty, the techniques of various embodiments and approaches described herein enable the disparity of actions to be captured based on a detection of interactions or movements that indicate an ameliorative action in a time compressed manner, e.g., such as clicking of a back button proximate in time after clicking an element of a GUI. A third core novelty of various techniques described herein includes detecting deceptive content and workflow patterns by natures of detecting an ethicality indicator, e.g., whether not an action matches a user's intent, based on the content interaction. An extension of the this is context aware to on-screen elements via natural language processing (NLP) to identify ethical anti-patterns and action disparities, e.g., actions that do not match the user's intent. As will be described in greater detail elsewhere below, these novelties are enabled by first understanding an intent of the user within a software design user experience workflow. A cloud monitoring service may be continually run to identify and alert users upon such users initiating actions that do not match determined user intents. An identification of intent “blocking” actions may be processed and alerts with amelioration steps for the user to remediate the process may be triggered. Furthermore, corrective actions may be recorded and situationally utilized to strengthen a growing knowledge corpus.

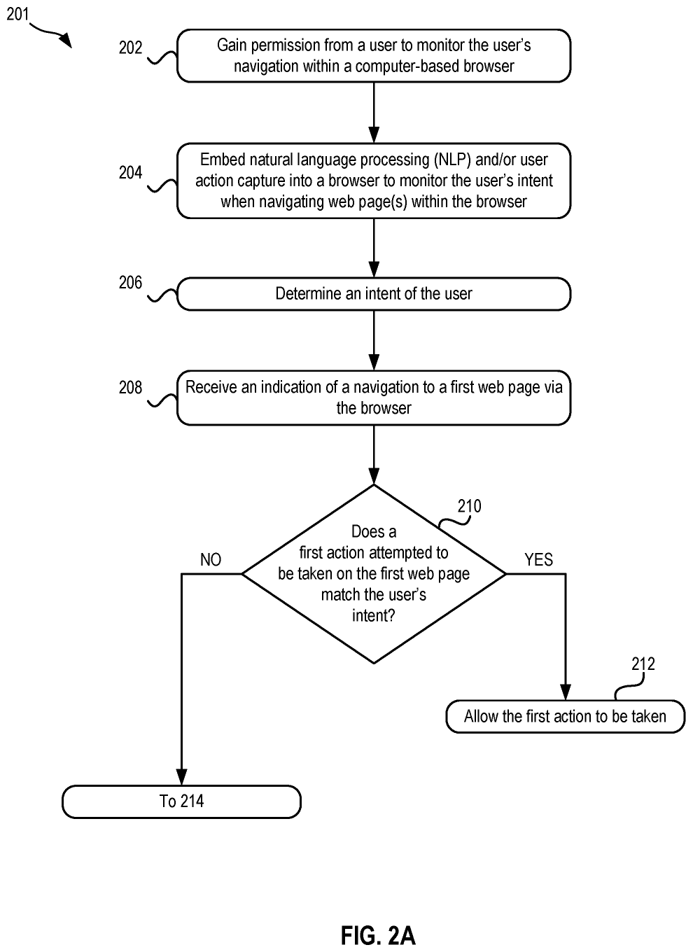

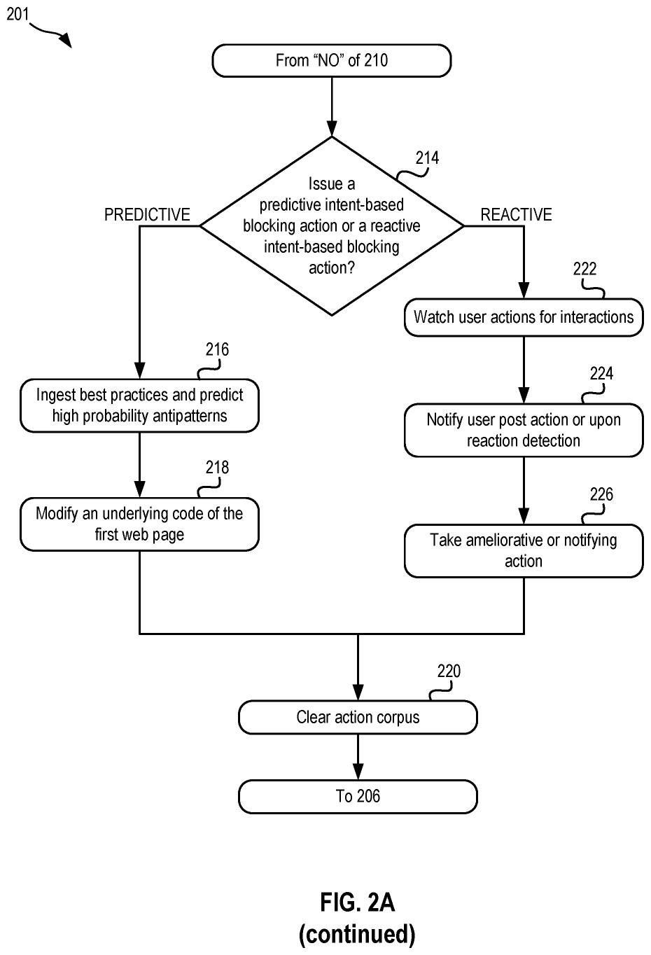

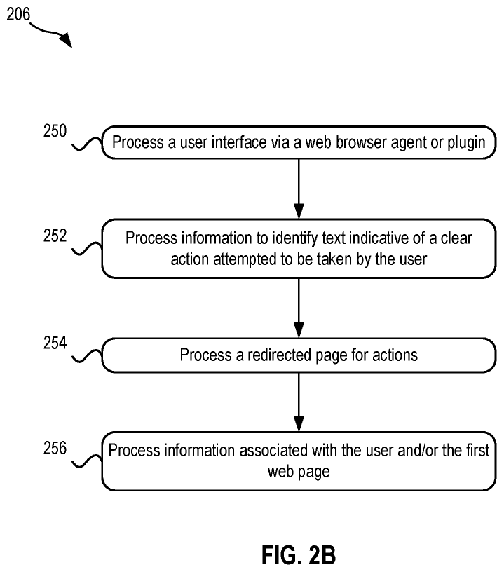

Now referring to FIG. 2, a flowchart of a method 201 is shown according to one embodiment. The method 201 may be performed in accordance with the present invention in any of the environments depicted in FIGS. 1-3C, among others, in various embodiments. Of course, more or fewer operations than those specifically described in FIG. 2 may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 201 includes various operations that involve monitoring user behavior associated with navigation on computer devices, e.g., such as navigations and actions performed while navigating within a computer based browser. In preferred approaches such monitoring is performed only subsequent to gaining permission from a user to monitor the user's navigation within a computer-based browser, e.g., see operation 202 of method 201. In one approach such permission may be gained subsequent to issuing a request for permission to the user. In another approach such permission may be obtained by the user opting into a service associated with the techniques of various embodiments and/or approaches described herein.

Operation 204 includes embedding natural language processing (NLP) and/or user action capture, into a browser to monitor a user's intent when navigating web page(s) within the browser. The browser may be a predetermined browser that is configured and used on a known type of computer device used by the user. The NPL may be configured to process natural language data that is uncovered as the user navigates web page(s) on the browser, and extract predetermined information from such data, e.g., such as contextual nuances. The user action capture may be of a known type. Furthermore, the user action capture may be configured to monitor and capture information associated with predetermined actions by the user, e.g., user navigation, scrolling, clicking associated with a cursor selection, temporary selection of text on one or more web page(s), etc.

As mentioned above, the NLP and/or the user action capture may be embedded into the browser to monitor the user's intent when navigating web page(s) within the browser. In some approaches the user's navigation may occur on a single webpage. In contrast, in some other approaches, the user's navigation may occur on more than one webpage. For example, in one approach, the user's intent may be monitored when navigating on a first web page in addition to on at least a second page. In such an example, the second web page may be a redirect page that is displayed on a display of the user's computer upon the user taking an action, e.g., clicking an option, on the first web page. In another example, the second web page may be a redirect page that is displayed on a display of the user's computer upon a predefined time out occurring on the first web page.

An intent of the user is determined, e.g., see operation 206. The intent of the user is preferably determined based on information obtained from the embedded NLP and/or the user patterns. This may include information that is based on the user navigation within one or more of the web page(s) within the browser. For context and as will be described elsewhere below, e.g., see operations 208-220, the user's intent is determined in order to ensure that any actions taken by the user thereafter conform to the user's intent. Various techniques for determining the user's intent are described in approaches below.

Looking to FIG. 2B, exemplary sub-operations of determining the user's intent are illustrated in accordance with one embodiment, one or more of which may be used to perform operation 206 of FIG. 2A. However, it should be noted that the sub-operations of FIG. 2B are illustrated in accordance with one embodiment which is in no way intended to limit the invention.

In some approaches, discovery of the user's intent may be based on the user reviewing content and indicating a clear action to take, e.g., unsubscribing from content delivery services. Accordingly, such actions may infer a clear known intent of the user. In another example, clicking a selection box using a cursor of the user may represent a definitively clear intent, e.g., unsubscribe. In other words, in some approaches, the user's intent may be quantified through the click of a button. In some approaches cloud monitoring service may constantly monitor for any clear intent actions, e.g., selection boxes clicked.

Sub-operation 250 of FIG. 2B includes processing a user interface. A web browser agent in one approach may be used to process the user interface. In another approach a plugin may be used to process the user interface. As a result of processing the user interface, one or more selectable options and/or user inputs of such selectable options may be determined. In some approaches the user interface may include a composite user interface that is configured to interact with two or more senses of the user. Predetermined contexts that are each associated with a different one of such selectable options and received inputs corresponding to such options may be used to determine the user's intent. For example, the user may navigate to a web page using a user interface, and the web page may include at least a “subscribe” selection box and an unsubscribe selection box. It may be determined from such selection boxes and/or user inputs of such selection boxes that the user's intent is updating a subscription status, e.g., either subscribing or unsubscribing.

Information is processed in sub-operation 252 to identify text indicative of a clear action attempted to be taken by the user. In some preferred approaches the information includes, e.g., content of the first web page, a document object model (DOM) tree, etc. Language processing techniques and/or user pattern recognition techniques that would be appreciated by one of ordinary skill in the art upon reading various of the descriptions herein may be used to process such information. In one approach, identifying text indicative of a clear action may include parsing various text portions of a web page and determining whether any of the text portions include predetermined trigger words. The predetermined trigger words may be words indicative of having a financial impact on the user, e.g., such as “purchase,” “subscribe,” “return,” “commit,” “promise,” “pay,” “dollar,” “monetary,” etc. In another approach, the predetermined trigger words may be words indicative of having a receiving impact on the user, e.g., such as “subscribe,” “address,” “phone number,” “availability,” “email,” “mail,” “package,” “download,” etc. The intent of the user may be at least partially determined based on identifying text portions including such trigger words and determining that the user has an interest in the text, e.g., has taken an action toward the text such as advancing a cursor toward a selection box associated with the text, has taken an action with the text such as by selecting the text with a cursor, has positioned the text on a predetermined portion of the screen such as about a center portion for at least a predetermined amount of time, has zoomed in on the text, etc.

Sub-operation 254 includes processing a redirected page for actions. Although operations of various approaches described herein are performed with respect to a first web page, in some approaches, one or more operations and/or sub-operations may additionally and/or alternatively be performed with respect to a redirect page, e.g., a redirect from the first web page. In some approaches, a redirected page may be displayed on the user device in response to the user taking a first action on the first web page, e.g., selecting a first option. In another approach, the redirect page may be displayed on the user device automatically, e.g., such as where the redirect page is a pop-up web page. The actions on the redirect page may include, e.g., cursor scroll, zooming, text selection, cursor traversal across the redirect page, text typing, etc. For example, the first web page may include an “confirm unsubscribe” feature that when selected presents a redirect page that is a page to confirm unsubscribing to the first web page. In such an approach, the actions on the redirect page may include cursor traversal toward the “confirm unsubscribe” feature.

Sub-operation 256 includes processing information associated with the user and/or the first web page. According to various approaches, the information associated with the user and/or the first web page may include user cursor location, options on a web page, etc. The NLP engine of the web page may be used to determine locations at which the cursor is located at on a given web page, different options available on a display of the user device, etc.

Predetermined user interface best practices that are developed based on other users and/or practices may additionally and/or alternatively be used to determine the intent of the user. For example, in some approaches the best practices may be developed by known techniques for performing trial and analysis, where the trial and analysis is performed user patterns data of other users. In some other approaches, a text input may additionally and/or alternatively be parsed to determine an intent of the user, e.g., “I want to unsubscribe from this paid service.” In yet another approach, text input from the user, e.g., in a help window, may additionally and/or alternatively parsed to determine the intent of the user. In yet another approach, a related action may be used to determine an intent of a user. For example, it may be determined that a user on a subscription based website may have an intent to unsubscribe from a paid subscription in response to a determination that the user has, within a predetermined amount of time, previously issued a charge back request to a credit card charge associated with the paid subscription, e.g., such as on a related second web page that is a banking web page.

With reference again to FIG. 2A, an indication of a navigation to a first web page via the browser may be received, e.g., see operation 208 of method 201. In one approach, the indication of the navigation to the first web page via the browser may be received subsequent to determining an intent of the user. For example, in such an approach, the intent of the user may be determined based on, e.g., one or more web pages previously navigated by the user, one or more other user patterns, a page having an option that was selected and navigated the user to the first web page, etc. In contrast, in some other approaches, the indication of the navigation to the first web page via the browser may be received and the user's intent may be, at least in part, determined thereafter.

An action may be taken in method 201 based on a determined intent of the user, that is tied to an action, e.g., button, link, etc., as triggered through the user's behavior. More specifically, with the user's intent determined, one or more operations are preferably performed to ensure that the user is prevented at least some types of actions from being performed by the user on the first web page that do not match with the user's intent. Accordingly, method 201 includes determining whether a first action attempted to be taken on the first web page matches the user's intent, e.g., see decision 210. In some approaches features of a webpage may be determined to not match with the user's intent. One or more techniques for comparing features of a webpage with information obtained from the embedded NLP and/or the historical user action capturing that would be appreciated by one of ordinary skill in the art upon reading various of the descriptions herein may be used to perform such a comparison to determine whether the first action matches the user's intent. In some preferred approaches, confirmation and validation of contextual confirmation of an action may be a prerequisite in order for the action to be determined as a correct path based on the intent of the user. The monitoring may use the NLP to correlate the user's intent with a clear representation of said action. In response to a determination that the user's intent is to complete an action, e.g., following through with a removal of subscription, a correlation between the user actually clicking an “intended action” button versus taking another action is preferably correlated. In some approaches, contextual confirmation may also be created by leveraging NLP across applications. For example, the user's intent may be determined, e.g., from text messages, calendar invitations, emails, etc., to indicate the intent and an expected timeline of the action.

In another approach, assuming that the user's intent is to unsubscribe from the web page, one or more selection boxes that re-subscribe and/or cancel an unsubscribe process that is in progress may be determined to be features of a webpage that do not match with the user's intent. In another example, assuming that the user's intent is to cancel an order, one or more “buy now” selection boxes may be determined to be features of a webpage that do not match with the user's intent. In yet another example, assuming that the user's intent is to not enroll in auto-pay and/or paperless options, one or more selection boxes that enroll the user in auto-pay and/or paperless options may be determined to be features of a webpage that do not match with the user's intent. In some approaches, types of selectable features of a webpage that do not match the user's intent may be determined from a table that includes a plurality of predetermined intents and one or more selectable features that do not match with the predetermined intents. Such a table may be output as a survey to the user device in order to be populated.

In response to a determination that the first action attempted to be taken on the first web page matches the user's intent, e.g., as illustrated by the “YES” logical path of decision 210, the first action may be allowed to be taken, e.g., see operation 212. In contrast, in response to a determination that the first action attempted to be taken on the first web page does not match the user's intent, e.g., as illustrated by the “NO” logical path of decision 210, an intent-based blocking action may be issued, to at least temporarily prevent the first action on the first web page. In some approaches, a predetermined type of blocking action may be performed in response to the determination that the first action attempted to be taken on the first web page does not match the user's intent, e.g., see blocking actions described in various approaches elsewhere below. In some other approaches, a type of blocking action may be additionally and/or alternatively determined. For example, it may be determined whether to issue a predictive intent-based blocking action or a reactive intent-based blocking action, e.g., see decision 214. For context, predictive intent-based blocking may in some approaches be based on monitoring. This allows the features, e.g., options, buttons, links, etc., on any digital space to be monitored for predicted intent. For example, in response to a determination, e.g., from the monitoring, that the user is going to click with a cursor on a feature that would negate the intent of the user, an alert may be output to warn the user. For example, the user may be alerted to a questionable item of the web page that may in actuality be present on the web page to confuse and/or be a dark pattern within a design of the user experience. In some approaches instead of reacting to the user's action, a DOM may be modified to cause the user experience to match the user's expressed intent. For example, the intended action's hierarchy may be increased through modification of an action's, e.g., color, size, position, etc. For further context, reactive intent-based blocking may in some approaches be based on monitoring. Reactive intent-based blocking may be used to alert the user that the user has just witnessed or taken an action that is counter intuitive to the user's intent, e.g., the intent that reactive intent-based monitoring software expects a user to process, based on the known intent. For example, within one use case, the user may be expected to unsubscribe from an e-mail distribution list based on the determined user's intent. It may be known that as the user initially selected an “unsubscribe” selection box, the unsubscribe process was initiated. Without use of various of the techniques described herein, upon the user completing narration through multiple screens and actions taken, the user presumes that they have completely followed a correct process and completed the intent of unsubscribing. However, as a result of using one of more of the techniques described herein, an alert may be output to a computer device of the user subsequent to the user completing the processing steps. The alert may be output based on the monitoring, e.g., as a part of an optional monitoring service, and is configured to alert the user that a final outcome of the user experience interactions may not match an expected intent as defined by the system. Accordingly, the user is alerted in order to allow the mistake to be corrected.

In some approaches, the type of intent-based blocking action that is determined to be issued in decision 214 may depend on the type of first action that the user is attempting to make on the web page. For example, in response to a determination that the attempted action includes an attempt to click a selection box and the user's cursor is within a predetermined proximity of the selection box, e.g., close in time to clicking the selection box, an intent-based blocking action that predictively prevents the first action from being taken on the first web page may be issued. As a result, the user is at least temporarily prevented from clicking the selection box. Accordingly, an outcome that does not match the user's intent is preemptively prevented by the intent-based blocking action. In contrast, in response to a determination that the attempted action includes general narration about a web page that includes ones or more selection boxes, an informative intent-based blocking action may be issued. Such an informative intent based blocking action may reactively prevent, e.g., see “REACTIVE” logical path of decision 214, the user from taking a first action, e.g., traversing to and clicking on one or more selection boxes of the web page.

In some other approaches, the type of intent-based blocking action that is issued may be determined randomly. The type of intent-based blocking action that is issued may alternatively be determined using a known type of machine learning technique that is modified to be configured to determine intent-based blocking action that have been previously successfully applied for other users with intents having a predetermined degree of similarity with the user's intent.

Various illustrative approaches of predictive intent-based blocking actions are described below, e.g., following the “PREDICTIVE” logical path of decision 214. In some approaches, issuing the intent-based blocking action may predictively prevent the first action from being taken on the first web page, e.g., the action is issued before the first action is taken. In some approaches, in order to determine an effective intent-based blocking action may predictively prevents the first action from being taken on the first web page, predetermined best practices may be ingested and high probability antipatterns may be predicted, e.g., see operation 216 of method 201. For context, antipatterns are actions that stray from a contextual flow of a predetermined number of previously taken actions, e.g., resubscribing subsequent to initiating an unsubscribe process. The best practices and/or the high probability antipatterns may be used to determine intent-based blocking actions that can be used to correct actions that do not match with the user's intent. For example, in some approaches the best practices and/or the high probability antipatterns may be determined based on prior iterations of issuing intent-based blocking actions being analyzed, e.g., using known techniques, and incorporated into a knowledge corpus for intent monitoring. From the intent monitoring a user intent may be determined and intent-based blocking actions may be issued to counteract actions that do not match the user's intent.

According to a more specific approach, issuing the intent-based blocking action may include modifying an underlying code of the first web page, e.g., see operation 218. For example, HyperText Markup Language (HTML) of the web page may be modified to prevent the first action from being taken on the first web page. The first web page may be set in a read-only state, e.g., for a predetermined amount of time, as a result of the modification to the underlying code of the first web page. In some approaches, the first web page being set in the read-only state for the predetermined amount of time may influence the user to focus on information included on the web page that details effects of taking the action on the first web page. Such information may reveal that taking the action on the first web page does not match the intent of the user. It should be noted however that in such an approach, without the first web page being set in the read-only state and thereby at least temporarily preventing the user from taking the action, the user likely otherwise would not have inspected and/or noticed such information. In some other approaches, a cursor speed on the first web page may additionally and/or alternatively be decreased while traversing over at least a portion of the first web page as a result of the intent-based blocking action being issued. Note that depending on the approach, the decrease to the cursor speed may be achieved under control of a user device such as a computer that displays the browser and/or as a result of the modification to an underlying code of the first web page. The cursor speed may be decreased a predetermined amount for a predetermined amount of time in some approaches. Such a blocking action may predictively prevent the first action from being taken on the first web page. For example, in some other approaches, the cursor speed may be decreased only while the cursor is located over predetermined portions of the web page, e.g., portions of the web page that includes a selection box that does not match the user's intent. In yet another approach, the cursor speed may be decreased only while the cursor is traversing across the web page toward a predetermined portion of the web page, e.g., a portion of the web page that includes a selection box that does not match the user's intent.

Dynamic HTML and cascading style sheets (CSS) modification may additionally and/or alternatively be used in some approaches to issue the intent-based blocking action. In one or more of such approaches, at least some items, e.g., features, on the first web page that align/match with the user's intent may be determined and/or at least at least some items, e.g., features, on the first web page that do not align with the user's intent may be determined. One or more of such items and/or action to interact with such items may be identified in a DOM and updated CSS may be dynamically injected to modify an associated appearance in order to clearly communicate potentially harmful and/or potentially non-harmful potentials to the user. For example, in one approach, one or more attempted actions that align with the user's intent may be modified to a green color, e.g., the cursor may be modified to a predetermined color such as a green color while traversing toward an item that matches the user's intent. In another approach, a selection box that matches the user's intent may be modified to a green color. In contrast, one or more attempted actions that do not align with the user's intent may be modified to a predetermined color such as red, e.g., the cursor may be modified to red while traversing toward an item that does not match the user's intent. In another approach, a selection box that does not match the user's intent may be modified to the red color.

Various illustrative approaches of reactive intent-based blocking actions are described below, e.g., following the “REACTIVE” logical path of decision 214. In some approaches, issuing the intent-based blocking action may reactively prevent the first action from being taken on the first web page. For example, issuing the intent-based blocking action may include issuing a notification either post action or in response to detecting an attempted action by the user, e.g., see operation 224. For example, the notification may be issued as a pop-up to a display of a computer device that the user is using to navigate to the first web page via the browser. In some approaches, such a pop-up may be positioned on the web page over one or more selection boxes that are determined to not match the user's interest. This pop-up serves as a notifying action, e.g., see operation 226. This way, the user does not miss the pop-up and select such a selection box, because the selection box is at least temporarily not available for selecting while the pop-up is present. Note that in the pop-up may optionally include a feature for selecting to close the pop-up and/or an acknowledgement that the pop-up is covering a selection box that is determined to be against the user's interest. Issuing the intent-based blocking action may additionally and/or alternatively include issuing a redirect in some approaches, e.g., such as a uniform resource locator (URL) redirect. The redirect may serve as an ameliorative action, e.g., see operation 226, to prevent the user from unknowingly taking actions that do not match with the user's intent. More specifically, as a result of issuing the intent-based blocking action the user device may be redirected from a URL of the first web page to a different URL of a second web page. In operation 222, monitoring is performed for user actions and/or interactions, e.g., such as attempted actions. In one example the URL redirect may be issued in response to a determination that the first action attempted to be taken on the first web page does not match the user's intent. This may result in the URL redirect being issued before a user is able to take the first action, e.g., the redirect is issued and occurs in response to a determination that the user's cursor is traversing toward a selection box that does not match the user's intent. In contrast, in some approaches the intent-based blocking may be issued subsequent to the user taking the first action on the first web page. For example, in one approach it may be assumed that the taken first action may include clicking a selection box on the first web page that does not match the user's intent. In such an approach, instead of the user device displaying a second web page having a URL that corresponded to the clicked selection box, issuing the intent-based blocking action may cause a third web page having a different URL than the first and second web pages to be displayed on the user device, e.g., a redirect page. In some approaches the user may remain unaware of the redirect from the second web page to the third web page based on no alert being output to the user device. In contrast, in some other approaches, an alert may be output to the user device that indicates that the user was redirected to the third web page based on the first action and the second web page not matching the user's intent.

Although various approaches above refer to the blocking action being issued to at least temporarily prevent the first action on the first web page, in some approaches the first action ends up being taken on the first web page by the user, and as a result the user is directed to a second web page as a result of the first action being taken on the first web page, e.g., such as where the second page is a redirected page. Method 201 optionally includes determining whether a second action attempted to be taken on the second web page matches the user's intent. Similar techniques to those described elsewhere herein for determining whether the first action attempted to be taken on the first web page matches the user's intent may be used to determining whether the second action attempted to be taken on the second web page matches the user's intent. In response to a determination that the second action attempted to be taken on the second web page does not match the user's intent, a second intent-based blocking action may be issued to at least temporarily prevent the second action on the second web page. The second intent-based blocking action may include any of the types of blocking actions described elsewhere herein, e.g., predictive, reactive, etc. In some approaches the second action may be taken on the second web page. It may be determined that the second action taken on the second web page does not match the user's intent. In some approaches an alert may be issued that the taken actions, e.g., the first action and the second action, do not match the user's intent.

Information associated with various operations of method 201 is in some preferred approaches preferably collected within a knowledge corpus for intent monitoring and correlating actions to build a robust collection of workflow design processing steps. These steps may aid the future predictive and reactive monitoring for the user and even a larger cloud sourced shared crowd based service potentially. In some approaches, this collection of information may incorporate whether an action was incorrectly identified as a dark pattern or unethical, e.g., as indicated by input received by the user and/or the user device. This way, the knowledge corpus improves recommendations moving forward. In some approaches, an end user may answer prompted questions output to the user device to help the system indicate whether an action and/or web page is ethical or not. For example, an illustrative one of such questions may include “what would your reaction be if every company did what this pattern does?” Another illustrative question may be “what would the consequences be?” or “would there be an issue if this action were published on the news?”

In an alternate approach, some iterations of performing method 201 may not consider such information associated with various previously performed operations of method 201. Accordingly, method 201 includes optionally clearing an action corpus, e.g., see operation 220 prior to returning to operation 206.

An additional illustrative operation of method 201 includes enabling common platform actions. For example, common actions may be stored on common platforms and significant deviation, e.g., as defined by a predetermined threshold, from a predetermined ‘norm’ may trigger guidance being issued to the user. According to a more specific example, in response to a determination that the user typically makes one-time payments, an enrollment by the user in auto-payment through dark pattern UI may be detected and determined to be an action that does not match the user's intent, e.g., to not enroll in auto-payment. Yet another additional illustrative operation of method 201 includes enabling a web browser extension. This option provides the end user an ability to enable the techniques of method 201 when the user would like to, e.g., such techniques are optionally not enabled at all times.

Various use cases of implementing techniques of method 201 are described below.

In one use case, it may be assumed that a user continues to receive spam emails from a retailer that the user recently purchased from. The user opens one of the emails and scrolls down to find the “unsubscribe” link. The user clicks “unsubscribe” indicating an intent to unsubscribe. This redirects the user to a page the retailer has produced for completing the “unsubscribe” process. The primary call to action on the page is a large button that says “confirm.” The user quickly clicks the button without reading any of the contextual information and moves on. What the user did not realize in taking the action was that the text before the “confirm” button states: “We only try to provide you with the most relevant of product updates and sales. Would you like to continue receiving our regular emails?” Beneath this action in light, small text is a selection box that matches the user intent and states: “No thanks, I just want to unsubscribe.” Accordingly, even though the user had indicated an intent to unsubscribe upon clicking “unsubscribe” on the email, the user's quick follow up click of “confirm” did not match an intent of the user's initial action. As a result of implementing the techniques of various embodiments and approaches described herein, such a use case in which the user performs actions that do not match the user's intent are avoided. More specifically, a disparity between the user's initial action and the quick follow up action is detected by scanning the proximal description that the user glazed over and using NLP to understand an effect of each potential action. Accordingly, upon determining that such a disparity exists, the attempted action of the user is intervened with an issued ameliorative action, e.g., such as an intent-based blocking action. Such an intent-based blocking action may include, upon the user clicking on “confirm,” issuing a notification to the user to notify the user of the disparity between the user's first action and the user's attempted second action.

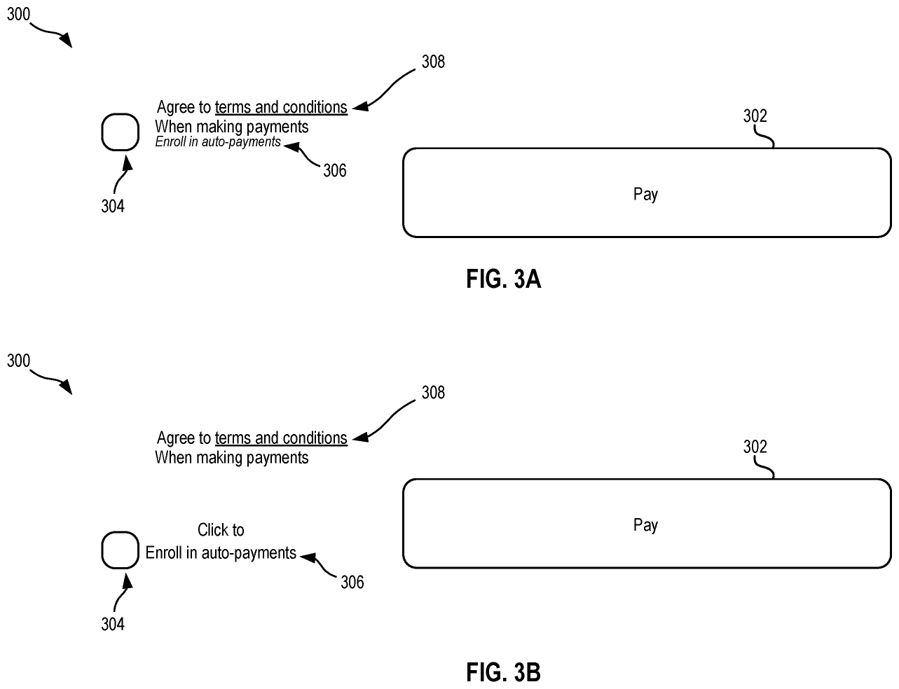

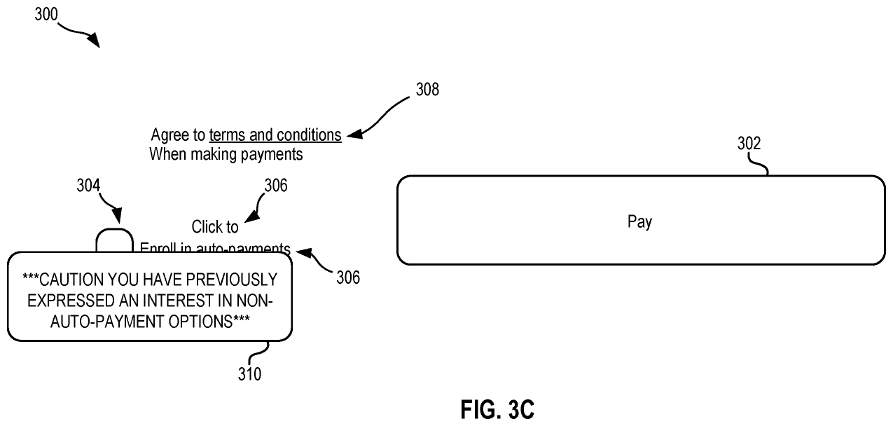

In another use case, timing aspects may be referenced to identify dark patterns, and upon identifying the dark patterns a proactive notification may optionally be issued. For example, it may be assumed that an attempted user action includes the user attempting to click ‘Accept and Book’ on an appointment form with a cancellation policy check box, and that a cancellation timeline has already passed. It may be determined that booking the appointment beyond the cancellation timeline does not match a determined intent of the user. As a result of implementing the techniques of various embodiments and approaches described herein, such a use case in which the user performs actions that do not match the user's intent are avoided. For example, in response to a determination that the attempted booking action does not match the user's intent, an intent-based blocking action may be issued. Issuing such an intent-based blocking action may include creating an alert/notification so the user knows/acknowledges that they are beyond the cancellation time limit to which they are committing. According to a more specific example, the user my attempt to book an appointment Thursday night for Friday morning and a cancellation policy may specify that cancelation be made twenty-four hours in advance for any refund. In such an approach, the intent-based blocking action may be an alert issued to the end user at the time of booking that the user is beyond a cancellation policy window. The alert may additionally ask the user whether they would like to continue booking. Another use case that implements techniques described in method 201 are described below, e.g., see FIGS. 3A-3C.

FIGS. 3A-3C depict a GUI architecture 300 of a web page, in accordance with several embodiments. As an option, the GUI architecture 300 may be implemented in conjunction with features from any other embodiment listed herein, such as those described with reference to the other FIGS. Of course, however, such GUI architecture 300 and others presented herein may be used in various applications and/or in permutations which may or may not be specifically described in the illustrative embodiments listed herein. Further, the GUI architecture 300 presented herein may be used in any desired environment.

It may be prefaced that the GUI architecture 300 may be displayed on a user device, e.g., such as a known type of computer having a display.

Referring first to FIG. 3A, the GUI architecture 300 includes a pay button 302, and a selection box 304 that enrolls a user to an auto-payment plan in response to being selected. The GUI architecture 300 also includes a portion of text 308 that includes a selection portion, e.g., the underlined “terms and conditions,” that if clicked, provides terms and conditions that apply when making payments using the pay button 302. It may be noted that that the enroll in autopayments selection box 304 may appear to be a prerequisite to clicking on the pay button 302. For example, upon a user viewing the GUI architecture 300 in FIG. 3A, it may appear to the user that the selection box 304 is a commonly used selection box for agreeing to terms and conditions of a payment web page. The “enroll in auto-payments” text 306 being a smaller font than the “Agree to terms and conditions” font may further cause this misinterpretation for a user viewing the GUI architecture 300.

It may be assumed that the user's intent is to make a one-time payment on a bill and that the user has already finished entering in account and payment information on a previous web page, and that GUI architecture 300 is a confirmation page. The user intends to just confirm the one-time payment and complete the transaction. It may further be assumed that the user has had bills from a vendor of this bill before and only processes one-time payments with no intention to enroll in auto-payments. However, because of this new web page design, the user initiates an attempted action to select the selection box 304 in an attempt to actually “Agree to terms and conditions” before confirming payment. However as mentioned elsewhere above, the relatively small text 306 indicates you agree to terms and conditions by clicking pay button 302 and confirming payment (and not selection box 304), and the checkbox is instead for auto-payment enrollment. Without a full understanding and in an attempt to quickly complete the transaction, the user may otherwise select the selection box 304 and think nothing of it. However, as a result of doing so, the user may be changed in the next month with another bill for services that the user did not intend to buy or use, e.g., thereby incurring an extra unnecessary payment. With reference now to FIGS. 3B-3C, as a result of issuing an intent-based blocking action in response to a determination that the attempted action of clicking the selection box 304 does not match the user's intent, the user does not incur the extra unnecessary payment. More specifically, as a result of the intent-based blocking actions being issued, the unintended action of enrolling in auto-payments is avoided despite the autopayments being based on dark patterns that are misleading to the user.

For example, in FIG. 3B, issuing the intent-based blocking action includes modifying an underlying code of the GUI architecture 300 to prevent the auto payment enrollment from being taken. It may be noted that the modification causes the “enroll in auto-payments” text 306 to be distanced from the selection box 304 to create a disassociation for the user. Furthermore, a size of the text 306 associated with the selection box 304 is enhanced and increased as a result of the modification.

Referring now to FIG. 3C, in another example, the intent-based blocking action may reactively prevent the user action from being taken on the GUI architecture 300. More specifically, issuing the intent-based blocking action may include issuing a notification 310 that warns the user that selecting the selection box 304 likely does not match with the user's intent.

Numerous benefits are enabled as a result of implementing techniques described in various embodiments and approaches herein. For example, users that have proven uncapable of performing web page based interactions without falling victim to dark user interface (UI) patterns are protected by various of the techniques described herein. Because these dark user interface (UI) patterns have proven capable of misleading users and complicating intended computer processes, various of the techniques described herein furthermore improve functioning of a computer by reducing an amount of computer processing that is performed to achieve a user's intent. This is because where users unknowingly perform actions that do not match the user's interest, additional computer processing is eventually consumed once the negative effects of the actions are experienced, e.g., to correct the actions taken that did not match the user's intent.

Furthermore, issuing an intent-based blocking action to at least temporarily prevent an action on a web page, where the action does not match an intent of a user, has heretofore not been considered in conventional techniques. In sharp contrast, users are plagued by dark user interface (UI) patterns that mislead users into making purchases and/or enrollments that they do not intent. Accordingly, the inventive discoveries disclosed herein with regards to use of intent-based blocking actions proceed contrary to conventional wisdom.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
embedding natural language processing (NLP) and/or user action capture into a browser to monitor a user's intent when navigating web page(s) within the browser;
receiving an indication of a navigation to a first web page via the browser;
determining whether a first action attempted to be taken on the first web page matches the user's intent; and
in response to a determination that the first action attempted to be taken on the first web page does not match the user's intent, issuing an intent-based blocking action to prevent the first action on the first web page.

2. The method of claim 1, wherein issuing the intent-based blocking action predictively prevents the first action from being taken on the first web page.

3. The method of claim 2, wherein issuing the intent-based blocking action includes modifying an underlying code of the first web page.

4. The method of claim 3, wherein the first web page is set in a read-only state as a result of the modification to the underlying code of the first web page.

5. The method of claim 1, wherein a cursor speed on the first web page is decreased while traversing over at least a portion of the first web page as a result of the intent-based blocking action being issued.

6. The method of claim 1, wherein issuing the intent-based blocking action reactively prevents the first action from being taken on the first web page.

7. The method of claim 6, wherein issuing the intent-based blocking action includes issuing a notification.

8. The method of claim 6, wherein issuing the intent-based blocking action includes issuing a redirect.

9. The method of claim 1, wherein the first action is taken on the first web page by the user, wherein the user is directed to a second web page as a result of the first action being taken on the first web page, and comprising: determining whether a second action attempted to be taken on the second web page matches the user's intent; and issuing a second intent-based blocking action to at least temporarily prevent the second action on the second web page.

10. The method of claim 1, wherein the first action is taken on the first web page by the user, wherein the user is directed to a second web page as a result of the first action being taken on the first web page, and comprising: determining that a second action taken on the second web page does not match the user's intent; and issuing an alert that the taken actions do not match the user's intent.

11. A computer program product, the computer program product comprising a computer readable storage medium having program instructions embodied therewith, the program instructions readable and/or executable by a computer to cause the computer to:
embed, by the computer, natural language processing (NLP) and/or user action capture into a browser to monitor a user's intent when navigating web page(s) within the browser;
receive, by the computer, an indication of a navigation to a first web page via the browser;
determine, by the computer, whether a first action attempted to be taken on the first web page matches the user's intent; and
in response to a determination that the first action attempted to be taken on the first web page does not match the user's intent, issue, by the computer, an intent-based blocking action to prevent the first action on the first web page.

12. The computer program product of claim 11, wherein issuing the intent-based blocking action predictively prevents the first action from being taken on the first web page.

13. The computer program product of claim 12, wherein issuing the intent-based blocking action includes modifying an underlying code of the first web page.

14. The computer program product of claim 13, wherein the first web page is set in a read-only state as a result of the modification to the underlying code of the first web page.

15. The computer program product of claim 11, wherein a cursor speed on the first web page is decreased while traversing over at least a portion of the first web page as a result of the intent-based blocking action being issued.

16. The computer program product of claim 11, wherein issuing the intent-based blocking action reactively prevents the first action from being taken on the first web page.

17. The computer program product of claim 16, wherein issuing the intent-based blocking action includes issuing a notification.

18. The computer program product of claim 11, wherein the first action is taken on the first web page by the user, wherein the user is directed to a second web page as a result of the first action being taken on the first web page, and the program instructions readable and/or executable by the computer to cause the computer to: determine, by the computer, whether a second action attempted to be taken on the second web page matches the user's intent; and issue, by the computer, a second intent-based blocking action to at least temporarily prevent the second action on the second web page.

19. The computer program product of claim 11, wherein the first action is taken on the first web page by the user, wherein the user is directed to a second web page as a result of the first action being taken on the first web page, and the program instructions readable and/or executable by the computer to cause the computer to: determine, by the computer, that a second action taken on the second web page does not match the user's intent; and issue, by the computer, an alert that the taken actions do not match the user's intent.

20. A system, comprising:
a processor; and
logic integrated with the processor, executable by the processor, or integrated with and executable by the processor, the logic being configured to:
embed natural language processing (NLP) and/or user action capture into a browser to monitor a user's intent when navigating web page(s) within the browser;
receive an indication of a navigation to a first web page via the browser;
determine whether a first action attempted to be taken on the first web page matches the user's intent; and
in response to a determination that the first action attempted to be taken on the first web page does not match the user's intent, issue an intent-based blocking action to prevent the first action on the first web page.
